(19) United States
(12) Patent Application Publication
(10) Pub. No.: US 2008/0172597 A1
(43) Pub. Date: Jul. 17, 2008

(54) Data Field Referencing Text Processing System

(75) Inventor: Jan DeHaan, Downington, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/014,231

(22) Filed: Jan. 15, 2008

Related U.S. Application Data
(60) Provisional application No. 60/885,021, filed on Jan. 16, 2007.

(51) Int. Cl. G06F 17/21

(52) U.S. Cl. 715/222

(57) ABSTRACT

A system identifies document (e.g., text processing application document) data fields similarly to the way a spreadsheet application references cells, to facilitate copying data fields that contain references to other fields. A text processing system enables user creation or editing of a document. The system includes a display processor for initiating generation of data representing an image. The image includes a document area for display and editing of a document and includes on a side of the document area, individual row identifiers and above or below the document area, data field indicators identifying corresponding individual data fields incorporated in a particular row of the document. A document processor associates an individual text data item with a data field incorporated in a particular row of the document. The data field has an associated location identifier identifying a position of the data field in the document by identifying a row, and position within a row, of the data field and the location identifier is automatically updated in response to movement of the text data item occurring during editing of the document.

This is a non-provisional application of provisional application Ser. No. 60/885,021 filed Jan. 16, 2007, by J. DeHaan.

### FIELD OF THE INVENTION

This invention concerns a text processing system enabling user creation or editing of a document and automatically tracking objects and associated data field location of an object in the document.

### BACKGROUND OF THE INVENTION

Known text processing systems support embedding a spreadsheet inside a document, or a document within a spreadsheet. However the interaction with an embedded item occurs through the use of a separate computer program. For example, in order to edit a spreadsheet within a document, the spreadsheet program is used and in order to edit a document within a spreadsheet, the document editing program is used. This means that a user needs to interact with two different programs concurrently. The integration between those programs is less than perfect. In particular, referencing a document field from within a spreadsheet or referencing a spreadsheet cell from within a document requires the use of macro programs or complicated formulas. Furthermore, data fields outside tables in a document still need to be referenced through field names. This means that the user has to create a unique name for each field and discovering the name of a field requires the user to change the display mode of the document processing application such that the application displays the names of the fields. A system according to invention principles addresses these deficiencies and related problems.

### SUMMARY OF THE INVENTION

A system identifies document (e.g., text processing application document) data fields using A1, $A$1, or R1C1 or another style incrementing identifiers, for example, similar to the way a spreadsheet application references cells, instead of using field names or bookmarks as is required by document editing applications, to facilitate manipulation (e.g., copying, moving, modifying) document data. A text processing system enables user creation or editing of a document. The system includes a display processor for initiating generation of data representing an image. The image includes a document area for display and editing of a document and includes on a side of the document area, individual row identifiers and above or below the document area, data field indicators identifying corresponding individual data fields incorporated in a particular row of the document. A document processor associates an individual text data item with a data field incorporated in a particular row of the document. The data field has an associated location identifier identifying a position of the data field in the document by identifying a row, and position within a row, of the data field and the location identifier is automatically updated in response to movement of the text data item occurring during editing of the document.

### BRIEF DESCRIPTION OF THE DRAWINGS

FIG. 1 shows a text document (non-spreadsheet) processing system enabling user creation or editing of a document, according to invention principles.

FIG. 2 illustrates column and row identifiers used by a document text processing system, according to invention principles.

FIG. 3 shows a user interface image used by a document text processing system illustrating spreadsheet-like features, according to invention principles.

FIG. 4 presents a formula in a user interface image used by a document text processing system, according to invention principles.

FIGS. 5 and 6 show a document text processor image and associated data tables used to implement the text processor image, respectively, according to invention principles.

FIGS. 7 and 8 show a further document text processor image and associated data tables used to implement the further text processor image, respectively, according to invention principles.

FIG. 9 shows a flowchart of a process performed by a text document processing system enabling user creation or editing of a document, according to invention principles.

### DETAILED DESCRIPTION OF THE INVENTION

A system references document data fields using A1, $A$1, R1C1 or other type identifiers, for example, in a similar manner to the way a spreadsheet application references spreadsheet cells, instead of using field names or bookmarks as is typically required by document editing applications. This facilitates copying a first data field that contains a reference to other data fields, to another document or document section, for example. The system comprises a document editing application that displays column and row headers. The row headers identify both document text line numbers and document table row numbers. Column headers identify the data fields or the document table columns. The placement of column headers is determined by a currently selected line or row. As a result identifying fields is made easier because a user does not need to toggle between a text view and a field-name view as is typically the case in known document editing applications.

The system allows a user of a document editing application to advantageously refer to document data fields as if they were cells in a spreadsheet application by using absolute and relative reference identifiers to document data fields. A data field may refer to other data fields and be referred to from other data fields by incorporating references to those fields in a formula, for example. Data field names may be used but are not mandatory. Line or paragraph numbers may be used in an equivalent manner to row numbers in a spreadsheet. Data fields within a line or paragraph may be identified by column name. For example “A” for a first data field in a row or paragraph, “B” for a second data field in a row or paragraph, etc. There is no need to refer to table names when referring to cells within a table, because table rows are treated as document lines (rows). That is, a row number is the same as a line number in a document and lines in the document are numbered sequentially. As a result spreadsheet functions may be advantageously applied to document data fields, while preserving the formatting capabilities found in traditional document editing applications The system advantageously enables spreadsheet cells to be referred to from within a document and document data fields to be referred to from within a spreadsheet, in a straight forward manner, without addition of executable (e.g., macro) programs or complicated references that involve object names and field names. The system similarly enables document data fields to be referred to from within data fields of the same or different documents.

An executable application, as used herein, comprises code or machine readable instructions for conditioning a processor to implement predetermined functions, such as those of an operating system, a context acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application manipulates the UI display images in response to the signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure. An area above or below a document area for display of a document includes a header or footer region of a document, for example.

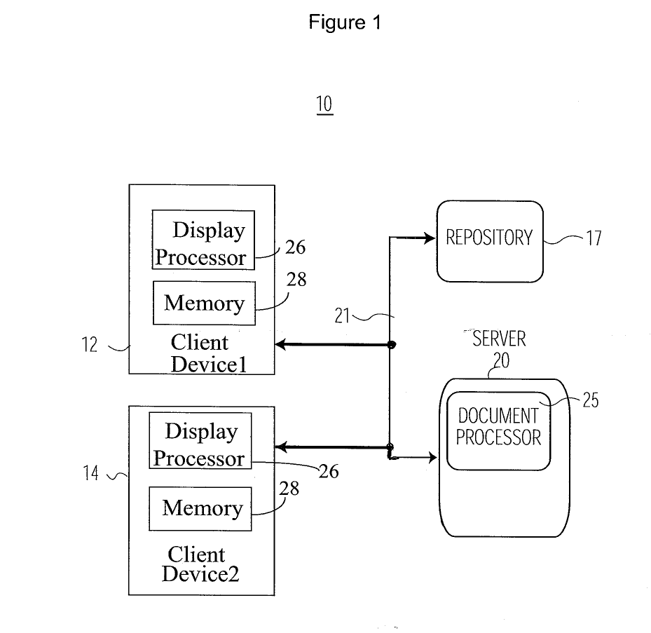

FIG. 1 shows text document (non-spreadsheet) processing system 10 enabling user creation or editing of a document, includes client devices (workstations, so called Personal Digital Assistants, cell phones) 12 and 14, repository 17, and server 20 inter-communicating via network 21. Workstations (client devices) 12 and 14 individually include memory 28 and a display processor 26. Display processor 26 provides data representing display images for presentation on workstation 12 and 14. Display processor 26 initiates generation of data representing an image including a document area for display and editing of a document. The image including on a side of the document area individual row identifiers and above or below the document area, data field indicators identifying corresponding individual data fields incorporated in a particular row of the document. Server 20 includes document processor 25 for associating an individual text data item with a data field incorporated in a particular row of the document. Ancillary data in data tables in repository 17 supports operation of system 10 and document processor 25. The ancillary data includes a data field having an associated location identifier identifying a position of the data field in the document by identifying a row, and position within a row, of the data field and the location identifier is automatically updated in response to movement of the text data item occurring during editing of the document.

System 10 enables a user to reference document fields using row and column identifiers as found in spreadsheet programs. For example, a row-column reference identifier “B5” refers to a second data field (column B) on line (row) 5 of a document. In a similar manner to a spreadsheet application, such reference identifiers may be absolute or relative. A copied absolute reference identifier refers to the same field as an original reference identifier so both an original and a copied reference identifier address data field “B5”, for example. Further, a copied relative reference identifier refers to a different data field than an original reference identifier. For example, if a data field identified as “C8” refers to data field “B5” (as a relative reference), it refers to a data field that is three (i.e., eight minus five) lines up and one (C versus B) data field to the left. If data field “C8” is copied to field “E13” (the fifth field in line 13), relative reference identifier “E13” refers to field “D10” (3 lines up and one data field to the left).

Further, as in a spreadsheet application, data field identifiers are adjusted automatically in response to user insertion or deletion of document lines or table rows. For example, in response to user deletion of line 2, identifier “B5” will change to “B4”. But unlike spreadsheet applications, a preferred implementation of system 10 inserts or deletes lines automatically as a result of word wrapping when fields or regular text are added or removed from a document line. In a preferred embodiment, system 10 displays row headers (like a spreadsheet application) together with row numbers that encompass both line numbers and table row numbers of a table in a document. Further, the row numbers are consecutive covering both document text and table rows eliminating, in one embodiment, a need to have separate reference identifiers to individual tables or document sections.

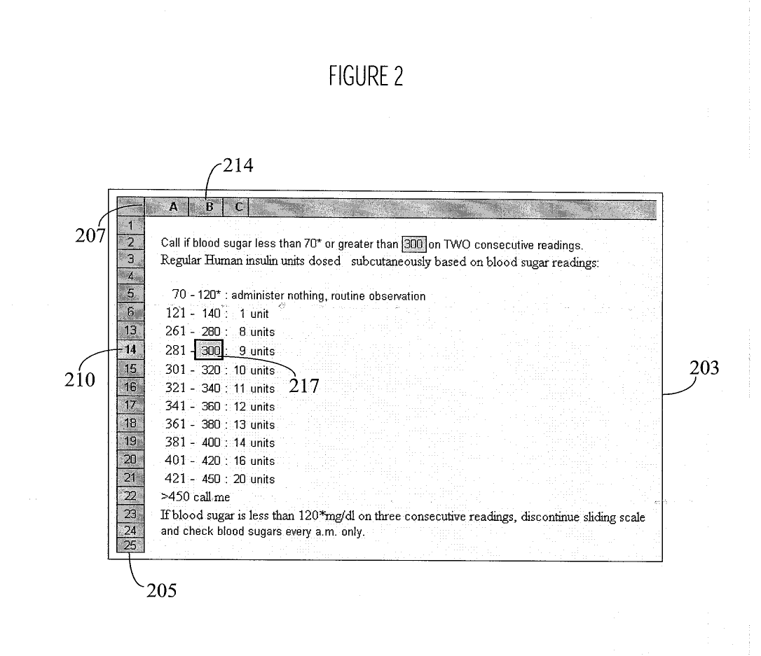

FIG. 2 illustrates column header identifiers and row identifiers (in row 207 and column 205) respectively in display image 203 used by document text processing system 10 (FIG. 1) in which both regular document text and a document table is subject to the same row numbering of column 205. In image 203 document lines and table rows are consecutively numbered but rows 7 to 12 are hidden in a similar manner to that supported by a spreadsheet application. A currently selected data field 217 (reference B14) is indicated together with associated highlighted column (B) and row (14) identifiers (items 214 and 210 respectively). Document processor 25 processes regular document text that does not need to be referenced as well as text items that need to be referenced. Further, the number of document data fields identified in row 207 varies from line to line (unlike spreadsheet applications). A currently selected line (i.e., that has the user interface focus) determines the number of column header identifiers, associated with the selected line, that are displayed in item (row) 207.

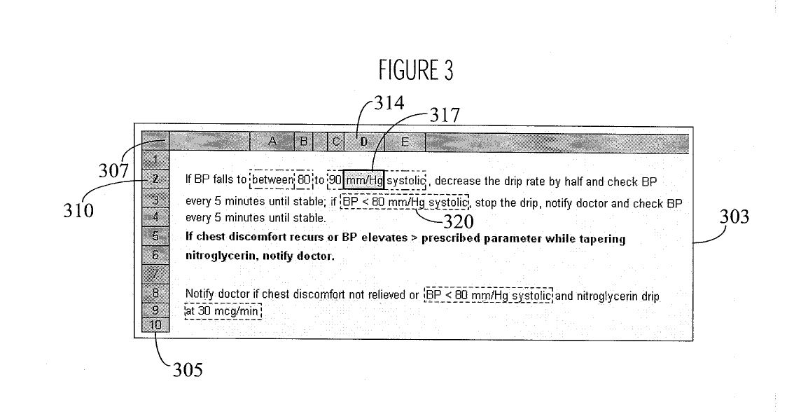

FIG. 3 shows user interface image 303 used by document text processing system 10 (FIG. 1) illustrating spreadsheet-like features. The number and size of column (data field) identifiers in header row 307 varies from row to row, Currently selected data field 317 (D2) is indicated together with associated highlighted column (D) of header row 307 and row (2) identifiers (items 314 and 310 respectively). Row (2) identified by item 310 in column 305 contains five indicated data fields corresponding to column headers A, B, C, D and E of header row 307. If row (3) is selected, header row 307 contains only one data field identifier (A) having a column width of different size and location than in row (2) and corresponding to data field 320.

Document data field identifiers in header row 307 may also be separated by regular text and a data field identifier may not be assigned to selected text strings in a row. For example, there is no column header identifier for the text string preceding the data field A item (“between”) in row (2). Also a data field value may be distributed to straddle other data fields. Data field item A2 refers to an item “between to”. However, the word “to” is displayed between fields B2 and C2. In one embodiment a user creates data field item A2 by using a formula for cell A2 which comprises

$$= ” between “ \vert \vert “ to ” ,$$

for example. The character | functions as a field delimiter. Similarly, the word “to” is displaced two data fields. e.g., to be between fields C2 and D2 using

$$= ” between “ \vert \vert \vert “ to ” .$$

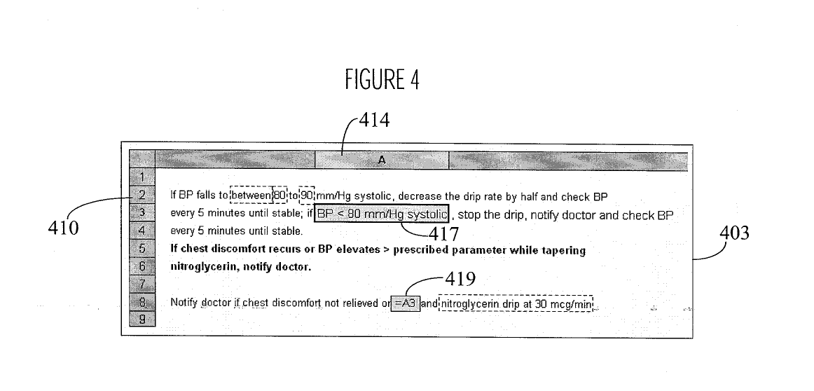

FIG. 4 presents a formula 417 in data field A3 (column and row items 414, 410) in user interface image 403 used by document text processing system 10 (FIG. 1). Field 417 indicates a field containing a text value and is replicated as item 419 in data field A8 (item 419 indicates a field containing a formula) by incorporation of reference identifier =A3 in data field A8. In one embodiment a user interface image employed by document text processing system 10 also displays a formula bar (not shown to preserve drawing clarity) as typically used in a spreadsheet application. The FIG. 1 document text processing system 10 advantageously combines features found in a spreadsheet application such as row and column headers, formulas, formula functions, and formula bar, with features found in a document editing application such as formatting, word wrapping, and outlining, in a single application employing a unified common way to reference document data fields and table cells. Thereby in system 10, document data fields and table cells are functionally equivalent.

System 10 enables a user to insert text in a data field by placing a cursor at a desired location, or by selecting document text and selecting a command (e.g. menu option, keyboard shortcut, toolbar button). If text is selected, the selected text becomes the content of the data field. In order to refer to another data field, a user enters a formula in the data field itself, or in a formula bar. The formula refers to the data field in a similar manner to the way a spreadsheet application does. A user discerns a field identifier from row and column headers or if the column headers do not reflect the row the user is referring to, the user may simply count the fields (e.g. 3^{rd} field is “C”, 6^{th} field is “F” etc. Alternatively system 10 may display the field reference when the user positions a (mouse) pointer over the field). Document text processing system 10 is usable for document processing for clinical treatment order entry and clinical documentation, for example.

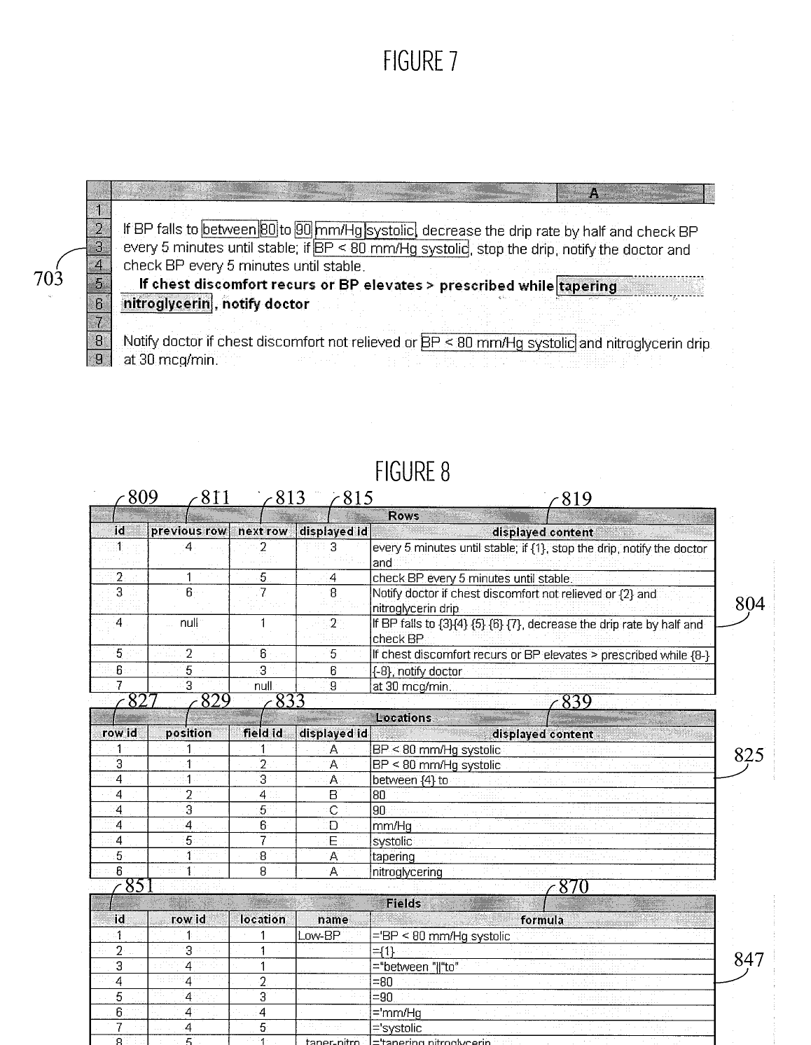

A data field may also contain pictures and any other object that can be inserted into a text document. Further, moving a data field boundary indicator e.g., in header row 207 FIG. 2 results in a change of how much data is included in the data field. A user may select any amount of contiguous data on a row and designate this selection as a field. The row and location indicators reflect the existence of this new field. A field may straddle more than one row. In that case the field has multiple row/location identifiers, one row/location identifier combination for each row straddled by the field (e.g., A5, A6 in FIG. 7). The position of the cursor determines which row indicator and which location indicators are shown by document text processing system 10. System 10 may automatically designate a certain amount of contiguous data as a data field. Examples are chapter and section headers, page headers and footers, captions, and foot notes and may employ a user configurable default data field allocation. The Default data field allocation may vary for different rows. Data fields may refer to data contained by other data fields by using the row and location identifiers associated with those other fields. If a change of position of a data field results in a different value of the row or location identifier of that data field, the text processing system automatically updates row/location references to that data field throughout the document to reflect the new values. Further, the value of a referenced data field may be used in formulas. Document text processing system 10 displays either a result of a formula, the formula itself or both, as determined by a user. The formulas may perform arithmetic or text manipulation.

An example implementation assigns a unique field identifier to an individual data field that does not change during the lifetime of the document. References to a data field use this unique identifier. However, the identifier value is invisible to the user. Instead, when document text processing system 10 needs to display the row and location identifiers, it determines the current position of a data field and sets the value of the row and location identifiers accordingly. If the text document includes a table, each table cell is a data field and each table row is a row or line in the document. The location identifier of a cell/data field corresponds to the location of the column in which the cell resides. Other data fields may reference table rows, table columns and groups of table cells. Data fields or a set of data fields may also have a unique name assigned by a user or system 10. System 10 advantageously combines this naming capability with the use of row/location identifiers when referring to a data field.

In one embodiment, row identifiers in a document are unique. In another embodiment, row identifiers on a document page are unique, but two pages may use the same row identifier. In that case a reference to a field needs to include the page identifier, row identifier and location identifier. In another variation the row identifiers are unique for each chapter or section. In that case a reference to a field includes the chapter/section identifier, row identifier and location identifier. In yet another embodiment, the row identifiers used by tables are kept separate from the rest of the document. In that case a reference to a data field (or table cell) needs to include the table identifier, row identifier and location identifier.

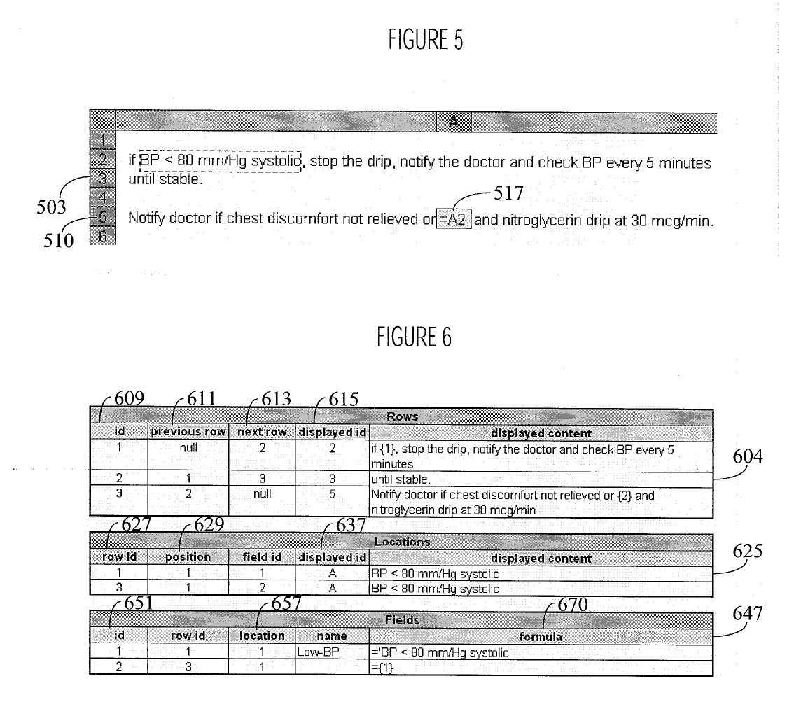

FIGS. 5 and 6 show a document text processor image 503 provided by display processor 26 and associated data tables 604, 625 and 647 stored in repository 17 used to provide text processor image 503. The values in id column 609 identify a row in Rows table 604. Previous row column 611 and next row column 613 determine a sequence in which document row content is displayed in text processor image 503. Both previous row column 611 and next row column 613 values refer to a value in row id column 609. The values in displayed id column 615 indicate what column 609 row id value a user sees in image 503 for that row. For example, for row id column 609 value 3 in the Rows table 604 shows up as row 5 (item 510) in the text processor image 503.

In Data Fields table 647, a value inside formula column 670 is associated with a value in data field id column 651. This id value is not displayed to a user. Instead when document text processing system 10 displays just text, an individual reference to a data field is replaced by text generated by a data field formula. When system 10 displays a formula, a data field reference indicates row and position of the data field as shown in text processor image 503. For example, Fields table 647 associates the formula={1} with field id 2 in column 651, a row id value 3, which refers to both the row identified by row id 3 in column 627 of Locations table 637 and id 3 in column 609 of Rows table 604, with location 1 in column 657, which points to a value in column 629 of Locations table 625. Further, “{1}” refers to a data field with id 1 and Data Field 1 is associated with data field location 1 (column 657) and location 1 is associated with row 1 and position 1 as indicated in the row with row id 1 columns 627 and 629 of locations table 625. Row 1 is displayed as row 2 as indicated in row with row id 1 of row table 604 and data field positions 1 and 3 are displayed as position (data field) A as indicated in both rows of column 637 of table 625. Therefore system 10 displays the formula “=A2” on row 5 (item 517) of image 503 which refers to the first (and only) field value (BP<80 mm/Hg systolic) displayed on row 2 of document text processor image 503.

FIGS. 7 and 8 show document text processor image 703 provided by display processor 26 and associated data tables 804, 825, 847 stored in repository 17 and used to provide text processor image 703. Image 703 includes additional text and data fields relative to the document of image 503. In Rows table 804 the sequence of rows in image 703 is identified by displayed row id of column 815 which does not directly correspond and map to the values column 809. Values in column 809 uniquely identify each row in table 825 and these values do not change once assigned. Values in column 811 and column 813 point to values in column 809. The first displayed row in text processor image 703 (row 2 in image 703, having displayed id 2 in column 815), corresponds to unique table row id 4 of column 809 of rows table 804. This data row has the value “null” in previous row column 811 and comprises displayed content indicated in associated corresponding column 819. The second displayed row in text processor image 703 (row 3 in image 703, having displayed id 3 in column 815), corresponds to row id 1 of column 809 of rows table 804. This second displayed (row id 1 in column 809 and row 3 of image 703) is indicated as a next row following the first displayed row of image 703 (row id 4 of column 809) of rows table 804 in next row column 813 associated with this first displayed text row. The other rows are similarly determined by data in Rows table 804. Blank rows (e.g., rows 1 and 7 of image 703) are not represented in Rows table 804, but document text processing system 10 incorporates them in image 703 in response to content of table 804.

In response to a user inserting text in a line of the document of image 703, other text may wrap (move) to a next line. Document text processing system 10 updates image 703 and updates the values in the “displayed id” column of both Rows table 804 and Locations table 825. If necessary, system 10 adds a row to the Rows table 804 and updates the values in the previous row and next row columns 811 and 813 respectively. This ensures that the new row is displayed in the correct location. If the text in displayed content column 819 of the Rows table 804 contains data field references in curly brackets (for example {1}), document text processing system 10 replaces the reference with the result of the corresponding formula found in Fields table 847. For example, in response to encountering the reference {7} in displayed content column 819 of Rows table 804 of table row id 4, document text processing system 10 finds the row in Fields table 847 which has corresponding id=1 (column 851), and replace {7} with the value “systolic” found in the displayed content column 839.

If the text in displayed content column 839 of Locations table 825 contains field references in curly brackets, system 10 replaces the reference with corresponding text found in Data Fields table 847. For example, in response to encountering the reference {4} in the Locations table 825 row having row id=4 and data field id=3 (column 833), document text processing system 10 finds the row in the Data Fields table 847 which has row id=4 (column 851), and replaces {4} with the value that results from evaluating “=80” found in corresponding formula column 870. Further, if a data field straddles more than one row in image 703, the data field is represented by more than one row in Locations table 825. For example, the data field with row id of 8 in column 851 of data field table 847 is represented by the last two rows in locations table 825. Thereby document text processing system 10 places the first part of the field value (“tapering”) on row 5 of image 703 and the second part (“nitroglycerin”) on row 6 of image 703.

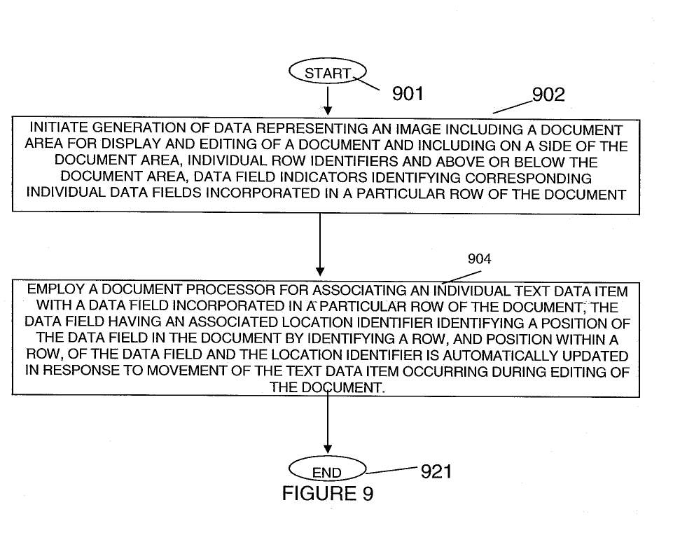

FIG. 9 shows a flowchart of a process performed by text document processing system 10 (FIG. 1) enabling user creation or editing of a document. In step 902 following the start at step 901, display processor 26 (FIG. 1) initiates generation of data representing an image. The image includes a document area for display and editing of a document and includes on a side of the document area, individual row identifiers. Above or below the document area, data field indicators identify corresponding individual data fields incorporated in a particular row of the document. In step 904, document processor 25 associates an individual text data item with a data field incorporated in a particular row of the document. The data field has an associated location identifier identifying a position of the data field in the document by identifying a row, and position within a row, of the data field and the location identifier is automatically updated in response to movement of the text data item occurring during editing of the document. The data field in one embodiment has an associated data field identifier which may be the same as, or different to, the location identifier. Document processor 25 also associates a data or image object with the data field incorporated in the particular row of the document and the location identifier is automatically updated in response to movement of the data or image object occurring during editing of the document.

The location identifier comprises a row identifier and a character position indicator indicating character positions in a row assigned to the data field. Further, the image includes a displayed data field indicator above or below the document area in character position alignment with the character positions in the row assigned to the data field. The displayed data field indicator also includes data field boundary indicators movable by a user in response to a drag and drop action, for example. The image also includes user selectable elements enabling a user to, select a specific row, select particular character positions on the specific row and designate the particular character positions on the specific row as a data field. The user selectable elements enable a user to assign multiple data fields, individually comprising one or more particular character positions, on the specific row and enable a user to assign different numbers of multiple data fields, individually comprising one or more particular character positions, on corresponding different rows.

The image provided by display processor 26 includes user selectable display elements enabling a user to select a row and designate particular character positions in the selected row as a data field. Also a data item in a data field having a location identifier may be referenced in a formula for arithmetic, algebraic or text manipulation. Further, a data field location identifier includes a page identifier and different pages may employ common row identifiers. A data field location identifier may include a chapter or section identifier, and a data field location identifier includes a chapter or section identifier, row identifier and character position indicator. In addition, a data field may straddle two or more rows and a corresponding data field location identifier includes a first row identifier and character position indicator and a second different row identifier and character position indicator. A document may also include a table and a reference to a table cell includes a table identifier, row identifier and character position indicator. The process of FIG. 9 terminates at step 921.

The systems and processes of FIGS. 1-9 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Text document processing system 10 enables a user to advantageously refer to document data fields, table cells, spreadsheet cells, image and other data objects in a similar manner to the way cells in a spreadsheet application are referenced, e.g., using absolute and relative reference identifiers. The processes and applications may in alternative embodiments, be located on one or more (e.g., distributed) processing devices accessing a network linking the elements of FIG. 1. Further, any of the functions and steps provided in FIGS. 1-9 may be implemented in hardware, software or a combination of both and may reside on one or more processing devices located at any location of a network linking the elements of FIG. 1 or another linked network including the Internet.

What is claimed is:

1. A text processing system enabling user creation or editing of a document, comprising:
a display processor for initiating generation of data representing an image, said image including a document area for display and editing of a document and including on a side of said document area, individual row identifiers and above or below said document area, data field indicators identifying corresponding individual data fields incorporated in a particular row of said document; and
a document processor for associating an individual text data item with a data field incorporated in a particular row of said document, said data field having an associated location identifier identifying a position of said data field in said document by identifying a row, and position within a row, of said data field and said location identifier is automatically updated in response to movement of said text data item occurring during editing of said document.

2. A system according to claim 1, wherein
said data field has an associated identifier and location identifier.

3. A system according to claim 2, wherein
said data field identifier and location identifier are the same.

4. A system according to claim 1, wherein
said location identifier comprises a row identifier and a character position indicator indicating character positions in a row assigned to said data field.

5. A system according to claim 4, wherein
said image includes a displayed data field indicator above or below said document area in character position alignment with said character positions in said row assigned to said data field.

6. A system according to claim 4, wherein
said displayed data field indicator includes data field boundary indicators movable by a user in response to a drag and drop action.

7. A system according to claim 1, wherein
said image includes user selectable elements enabling a user to, select a specific row,
select particular character positions on said specific row and
designate said particular character positions on said specific row as a data field.

8. A system according to claim 7, wherein
said user selectable elements enable a user to assign multiple data fields, individually comprising one or more particular character positions, on said specific row.

9. A system according to claim 8, wherein
said user selectable elements enable a user to assign different numbers of multiple data fields, individually comprising one or more particular character positions, on corresponding different rows.

10. A system according to claim 1, wherein
said image includes user selectable display elements enabling a user to select a row and designate particular character positions in said selected row as a data field.

11. A system according to claim 1, wherein
a data item in a data field having a location identifier is referenced in a formula for arithmetic, algebraic or text manipulation.

12. A system according to claim 1, wherein
a data field location identifier includes a page identifier and different pages may employ common row identifiers.

13. A system according to claim 1, wherein
a data field location identifier includes a chapter or section identifier, and a data field location identifier includes a chapter or section identifier, row identifier and character position indicator.

14. A system according to claim 1, wherein
a document includes a table and a reference to a table cell includes a table identifier, row identifier and character position indicator.

15. A system according to claim 1, wherein
a data field may straddle two rows and a corresponding data field location identifier includes a first row identifier and character position indicator and a second different row identifier and character position indicator.

16. A system according to claim 1, wherein
said document processor associates a data or image object with said data field incorporated in said particular row of said document and
said location identifier is automatically updated in response to movement of said data or image object occurring during editing of said document.

17. A text processing system enabling user creation or editing of a document, comprising:
a display processor for initiating generation of data representing an image, said image including a document area for display and editing of a document and including on a side of said document area, individual row identifiers and above or below said document area, data field indicators identifying corresponding individual data fields incorporated in a particular row of said document and said image includes user selectable elements enabling a user to,
select a specific row,
select particular character positions on said specific row and
designate said particular character positions on said specific row as a data field; and
a document processor for associating an individual text data item with a data field incorporated in a particular row of said document, said data field having an associated location identifier identifying a position of said data field in said document by identifying a row, and position within a row, of said data field and said location identifier is automatically updated in response to movement of said text data item occurring during editing of said document and a data item in a data field having a location identifier is referenced in a formula for arithmetic, algebraic or text manipulation.
